(19) United States
(12) Patent Application Publication
(10) Pub. No.: US 2004/0062272 A1
(43) Pub. Date: Apr. 1, 2004

(54) Architecture for transitioning digital loop carrier systems to packet switching

(76) Inventors: Gregory J. Greco, Frisco, TX (US); William E. Pugh, Williamsburg, VA (US); William J. Vivino JR., Wayne, NJ (US)

Correspondence Address: LAW OFFICE OF JOHN LIGON, 505 HIGHLAND AVENUE, P.O. BOX 43485, UPPER MONTCLAIR, NJ, 07043, US

(21) Appl. No.: 10/261,280

(22) Filed: Sep. 30, 2002

(51) Int. Cl. H04J 3/16

(52) U.S. Cl. 370/466; 370/411

(57) ABSTRACT

A method and architecture for transitioning the embedded base of Digital Loop Carrier access systems from the current narrowband circuit-switched paradigm—i.e., Synchronous Transfer Mode transport and Time division Multiplexed—to an Asynchronous Transfer Mode transport and ATM network interface paradigm. The invention operates to terminate the control data links from legacy DLC equipment, and to provide a protocol conversion function that enables these links to interface with the associated control and call processing structures of a serving packet switch. An additional function of the invention is the interfacing for bearer channels of the STM feeders from the legacy DLC and the provision of a Synchronous to Asynchronous Conversion function on such feeders.

### FIELD OF INVENTION

The invention relates to communications networks, and more particularly to a process for transitioning legacy Digital Loop Carrier transport arrangements from Synchronous Transfer Mode to Asynchronous Transfer Mode transport.

### BACKGROUND OF THE INVENTION

The transmission of electronic communications signals, both voice and data, is now predominantly carried out in digital form. Although the message-switching paradigm associated with traditional voice communications systems continues to characterize significant portions of the communications network infrastructure, it is generally recognized that such digitized information can be more efficiently transmitted by means of packet switching. Instead of maintaining an end-to-end channel of communications for the length of the information transfer, as in traditional message switching systems, packet switching breaks the information into smaller packets that are transmitted separately over the most efficient route available, and then reassembled at the destination for the packetized message. Because of this advantage, a clear trend toward replacement of message switching network components with packet switching elements has been seen over the past decade or so.

Similarly driving communications networks toward packet switching is the fact that the computer and internet revolution has greatly increased the amount of data traffic being carried by the national communications infrastructure, with the result that the historic voice orientation of that communications infrastructure has largely given way to a data-centric bias in those networks. Moreover, with the data traffic increasingly involving high-bandwidth graphic and video data, the communications networks are called on to provide much higher bandwidth channels than were needed for voice traffic. Digital packet networks offer the potential for high-speed data transfers that are needed to provide timely transfer of such large data files.

At the level of inter-nodal trunking in the communications networks, packet switching links and switching nodes have been established more or less in parallel with existing message switching links, and much of the recent growth in aggregate network capacity has been provided via such parallel packet switching links. However, for the portion of the communications path between a network node (typically a telephone central office) and the end user, such a parallel transition from message switched to packet switched transmission has not heretofore been economically practical.

The interface at which individual users normally connect to the communications network is known as a Digital Loop Carrier (DLC) interface. Although a detailed description of the DLC interface is not needed for describing the invention here, it is noted that the DLC handles the multiplexing of individual user signals onto a loop carrier for transport to a switching node, as well as the conversion between the analog format of most user equipment and the digital format of network transport. The legacy DLC equipment typically operated by the incumbent telephone carriers is based on Synchronous Transfer Mode (STM) transport, corresponding to the historic circuit-switched paradigm of the communications network. In order to properly interface with packet switched transport, it is necessary for the DLC equipment to operate in a packet mode which may be the Asynchronous Transfer Mode (ATM) or the Internet Protocol (IP) mode, or one of these modes encapsulated in the other, e.g. IP over ATM. The Throughout the balance of this application, the packet transport mode will generally be referred to as “ATM” for convenience of notation; however, it should be understood that other packet protocols are included where contextually appropriate.

The prior art has dealt with the changeover of DLC equipment from STM and message switched transport to ATM and packet switched transport through a wholesale change out of existing STM equipment with ATM equipment. This of course represents a very large expense for the incumbent telephone carriers, with the result that the transition from message to packet switching for “local loop” equipment has proceeded much more slowly than has occurred with internetwork trunking.

### SUMMARY OF THE INVENTION

Accordingly, it is an object of the invention to provide an economically practical method for transitioning the “local loop” of communications networks from circuit switched transport to packet switched transport. To that end, a method is provided for transitioning the embedded base of Digital Loop Carrier access systems from the current narrowband circuit-switched paradigm—i.e., Synchronous Transfer Mode transport and Time division Multiplexed—to a packet mode such as Asynchronous Transfer Mode transport and ATM network interface paradigm. In particular, the invention operates to terminate the control data links from legacy DLC equipment, and to provide a protocol conversion function that enables these links to interface with the associated control and call processing structures of a serving packet switch. An additional function of the invention is the interfacing for bearer channels of the STM feeders from the legacy DLC and the provision of a Synchronous to Asynchronous Conversion function on such feeders. The invention further operates to provide an interface to the loop testing function of the legacy DLCs in response to test messages from the serving packet switch complex. Finally, the invention operates to bring all of the lines subtending the host packet terminal under the operational paradigm and the Operational Support System (OSS) structure of the new packet environment.

### BRIEF DESCRIPTION OF THE FIGURES

FIG. 1 provides a schematic layout of a legacy Subscriber Loop Carrier system as implemented between a Remote Terminal and a Central Office.

FIG. 2 provides a schematic layout of a combined legacy Subscriber Loop Carrier system and a parallel broadband asynchronous link as implemented between a Remote Terminal and a Central Office.

FIG. 3 provides a schematic layout of a Subscriber Loop Carrier system adapted to support both narrowband and broadband transport, as implemented between a Remote Terminal and a Central Office.

FIG. 4 illustrates an exemplary layout of application packs for an AnyMedia Access System.

FIG. 5 provides a schematic layout of a DLC system implemented according to the invention.

### DETAILED DESCRIPTION

In the hierarchy of communications networking, the communications link between the end user and the entry switching node (for a given user) of that network is usually referred to as the “local loop.” In early communications networks, that local loop was typically implemented as a continuous run of twisted-pair copper cable from the end user's location to that entry switching node, which node was usually referred to as the user's “Central Office” (CO) and the switching operation at that node was typically referred to as a local, or subscriber switch. As the number of users served by a given CO grew, however, it became more efficient to consolidate groups of end-users at a location proximate to the end-user group, but somewhat distant from the CO. At the remote consolidation site, traffic from all of the served in users is multiplexed onto a carrier channel and transported from the remote location to the CO via that carrier channel. At the CO, the carrier channel is demultiplexed to recover the signal of each served user, which signals are then provided to the associated local switch for further routing through the communications network to a destination indicated by the calling party.

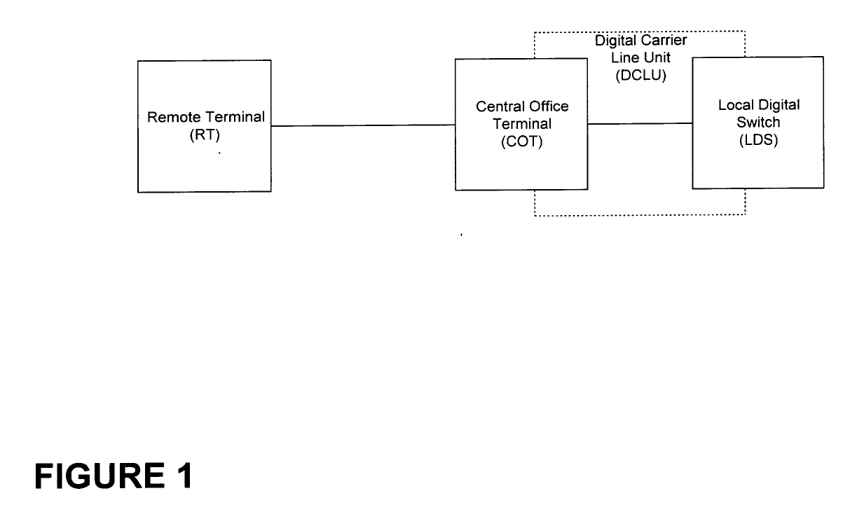

The combined operations of multiplexing the multiple user signals at the remote site, transmission of the multiplexed signals via a carrier channel, and recovery of the individual user signals at the CO by demultiplexing that carrier channel, became known as a Subscriber Loop Carrier (SLC) system. An SLC system usually consists of two separate subsystems: the Central Office Terminal (COT) and the Remote Terminal (RT). A schematic diagram of a typical SLC system and its interface with the CO is shown in FIG. 1.

The RT provides the operation of multiplexing the user signals terminated at that location for consolidation, and the COT forms the complementary operation of demultiplexing to recover the original signals. With modem telecommunications systems, in which analog voice signals are converted to a digital bit stream for transport through the network, the conversion operation between analog and digital signals is also provided at the RT. Consistent with the conversion from analog to digital signals at the RT, the multiplexing carried out at the RT is typically done using Time Division Multiplexing (TDM).

Note that, with the adoption of digital transport for the SLC system, that functional arrangement became known as a “Digital Loop Carrier” (DLC) system. Accordingly, the “DLC” term will be used hereafter to refer to such loop carrier systems, except for reference to proprietary systems that use the SLC nomenclature.

The RT is connected to end-users or subscribers via Voice Frequency (VF) circuits, which, as noted above, are usually implemented as twisted-pair cable. The network side of the RT is, in turn, typically connected to the COT via one or more DS-1 channels. The DS1 channel(s) may be implemented via either an electrical or an optical transmission medium. Finally, the output of the COT is provided as an input to the local switch at that CO. In keeping with the fact of signals in the DLC system being transmitted in digital form, that local switch is shown in FIG. 1 as a Local Digital Switch (LDS).

The DLC system shown via solid lines in FIG. 1—i.e., having the COT as a separate functional unit from the LDS—is known as a “universal” DLC system. In more modern systems, which are known as “integrated” DLC systems, the separate COT is replaced by a “Digital Carrier Line Unit” (DCLU), which is integrated with the LDS and provides a direct interface between the DS1 carrier channel and the LDS. That integrated DCLU function is indicated by the dashed lines connecting the COT and the LDS in the figure.

Even though the modem DLC system has been converted to transport signals in digital form, the underlying transport protocol continues to be Synchronous Transport Protocol, which is essential for the TDM multiplexing usually carried out by the DLC systems. For this and other technical reasons (not material to the present disclosure), packet switched transport, which relies on Asynchronous Transport Protocol (ATM), cannot be effectively handled via the presently configured DLC systems. Moreover, even if the protocol issue was resolved, the bandwidth typically available in a DLC system would unduly restrict the bandwidth requirements of much of the data traffic offered for transport.

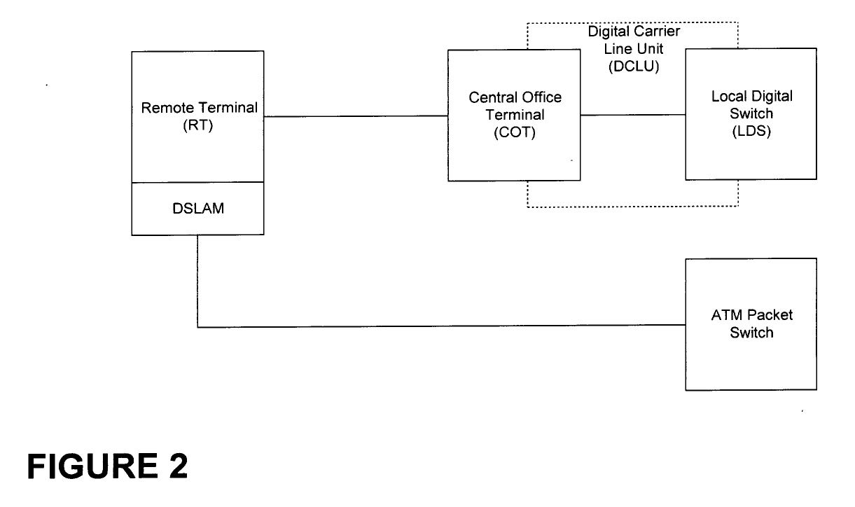

Short of a complete changeout of the existing DLC equipment at an RT, which, as suggested earlier, is not an economically feasible approach, the need to provide ATM transport in the local loop has usually been dealt with by provisioning a parallel data link from the RT back to the CO. Such an implementation is typically carried out by installation at an RT of an auxiliary piece of hardware known as a Digital Subscriber Line Access Multiplexer (DSLAM). This configuration is schematically illustrated in FIG. 2. The DSLAM facilitates the transmission of broadband asynchronous data signals between suitably configured user modems and an ATM transport network. The broadband asynchronous service so provided is commonly referred to as Asymmetric Digital Subscriber Line (ADSL) service. [It is to be noted that various other forms of Digital Subscriber Line service are known and often referred to by the generic designation “xDSL.” Although the discussion herein will exclusively use the term ADSL for such broadband service, it should be understood that other such DSL services are included where contextually appropriate.] At the subscriber side, the DSLAM connects with each of a served population of ADSL modems, typically via twisted-pair cable. The signals from those served users are then multiplexed by the DSLAM and transmitted, via a high-capacity asynchronous transport link, to the ATM transport network.

There are several problems with this approach. One, the DSLAM equipment is very expensive and thus the deployment of such equipment at the RTs is undertaken by the carriers on a quite conservative schedule. Moreover, although the deployment of a DSLAM at a given RT location provides a broadband asynchronous channel for a limited population of users willing and able to pay a premium charge for such a facility, it does nothing for the much larger population of existing DSL-served users, in terms of better data throughput. Equally important, the provisioning of a DSLAM at an RT provides little, if any benefit in respect to the overall goal of moving the local loop infrastructure from the STM, message-switched paradigm to an ATM, packet-switched paradigm. As described hereafter, each of these goals is met by the invention.

The circuit multiplexing and digital/analog conversion carried out at the RT in a DLC system operates to digitize and multiplex sets of 24 subscriber line signals for transport over a single DS-1 channel between the RT and the LDS (as well as the reverse process for downstream signals). A common implementation of the digitization and multiplexing function at the RT is exemplified in the SLC-96 system provided by Lucent Technology, Inc, the assignee of the present application. In those SLC-96 systems, four sets of 24 subscriber lines (i.e., 96 lines) are digitized and multiplexed with the resulting combined signals transported between the RT and the LDS via 4 DS1 channels. The immediately-following generation of the Lucent Technologies RT DLC equipment, known as SLC-5, provided digitization and multiplexing for 192 subscriber lines for transport over 8 DS-1 channels (and which 192 lines were logically partitioned into two 96 line sets). A high percentage of legacy DLC systems in use today are implemented as either SLC-96 or SLC-5 systems (or functional equivalents provided by competing vendors).

The physical implementation of the DLC functions described above is typically realized in a set of plug-in “line cards” that contain electronic circuitry for carrying out those functions. A base is provided containing slots for the line cards to be plugged into, and for providing the electrical interconnections among the line cards and other cards providing supporting electronic and/or processing functions for the line cards, as well as input/output interfaces for the assembly. In the parlance of the industry, the base assembly is referred to as a “shelf” and is itself mechanically and electrically connected at a predetermined position in an RT cabinet.

In an analog to the channel bank idea originally associated with analog-to-digital conversion and multiplexing carried out for interexchange links, the SLC-96 shelf and its associated cards became known as a channel bank, a term which is also applied to the position in which such a shelf fits in the RT cabinet. Similarly, the SLC-5 system, which serves double the number of lines served by an SLC-96 system, is said to represent a dual channel bank.

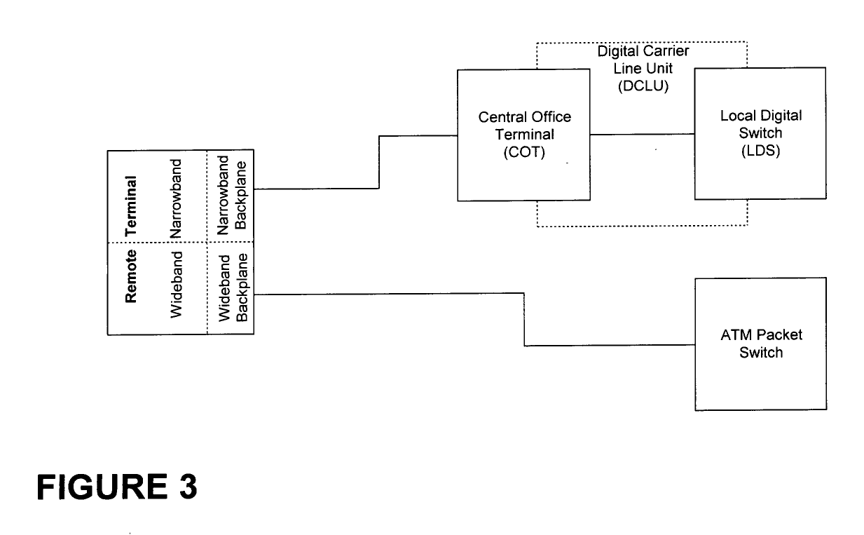

The SLC-96 and SLC-5 systems are strictly limited to “narrowband” carrier transport—ie., the transport of groups of 24 VF lines TDM multiplexed into a 1.54 Mhz DS-1 channel. The current generation of DLC electronic equipment, however, as typified by Lucent Technology's AnyMedia Access System (AMAS), provides both a narrowband and a broadband bus and associated I/O interfaces. Accordingly, that current generation equipment can interface with both the DS-1 narrowband channels and one or more broadband channels connecting the RT with a broadband ATM switch. A DLC system based on the use of one or more AMAS shelves in an RT cabinet is schematically illustrated in FIG. 3.

Advantageously, current generation DLC equipment, such as the AMAS system, can provide more than the full capacity of an SLC-5 system for VF lines (192 lines), along with various broadband services, such as ASDL service, using the same dual channel bank RT cabinet interface as for an SLC-5. Thus, the VF lines would be digitized and multiplexed by narrowband equipment and interfaced to the DS-1 channels connected to the LDS via the narrowband backplane. Similarly, selected broadband services would be provided via specialized broadband line cards, the broadband backplane and the associated broadband channel connecting to the ATM switch.

As noted previously, a complete changeout of the DLC equipment at an RT to install current generation equipment can be prohibitively expensive for the incumbent carriers. However, most RT cabinets provide at least 4 dual channel bank (DCB) positions, and it will in many cases be economically practical to install at least one current generation shelf in an RT cabinet to serve ADSL users in the service area of the RT, along with the VF lines previously served by an SLC-5 shelf in that DCB position. Alternatively, a new current generation DLC shelf may be installed in an unused DCB slot in the RT cabinet to serve both additional VF lines and ADSL lines. In either of these configurations, the method and architecture of the invention can be implemented to convert the VF lines served by the legacy SLC-5/96 equipment located (and continued in operation) at that RT from the STM, message-switched regime of the legacy equipment to an ATM, packet-switched regime.

At its essence, the architecture of the invention consists of interface circuits and associated software that enables the STM feeder and TDM switch interface of a legacy DLC to be terminated at the RT site onto the ATM backplane of a broadband DLC (such as an AMAS Shelf), and thereby to interface directly into a packet switch, such as the Lucent Technologies 7R/E. For convenience of reference, that broadband section of the RT DLC equipment and its associated ATM backplane will be referred to hereafter as the “host packet terminal.” It will be apparent to those skilled in the art, from the discussion following, that this architecture will also be applicable to the termination of such legacy DLC signals onto the backplane of a DSLAM or onto the backplane of an ATM Access Multiplex (or by equivalent cable connection to any of these network elements) located at RT site.

The essential functions of the invention are: (1) to terminate the control data links from the legacy DLC (e.g., TR-08, GR-303, SLC-5 FPC, SLC-5 FPI, or other open or proprietary interface) and to provide a protocol conversion function which enables these links to interface with the associated control and call processing structures of the serving packet switch; (2) to interface to the bearer channels of the STM feeders from the legacy DLC and provide the Synchronous to Asynchronous Conversion Function on these feeders; (3) to interface the resulting ATM cell streams onto the backplane of the host packet terminal; (4) to interface to the loop testing functions of the legacy DLCs in response to test messages from the serving packet switch complex; and (5) to bring all of the lines subtending the host packet terminal under the operational paradigm and OSS structure of the new packet switching environment.

The discussion hereafter of the invention is focused on the configuration and capabilities of the Lucent Technologies AnyMedia Access System, but it should be apparent to those of skill in the art that the method and architecture of the invention can be applied to any DLC equipment that provides broadband I/O interfaces to the communications network. Additionally, it should be noted that the electronic cards used in the AMAS (corresponding to the line cards of an SLC-96/5 system for VF lines) are characterized as “application packs” and that terminology will be used hereafter to describe such cards.

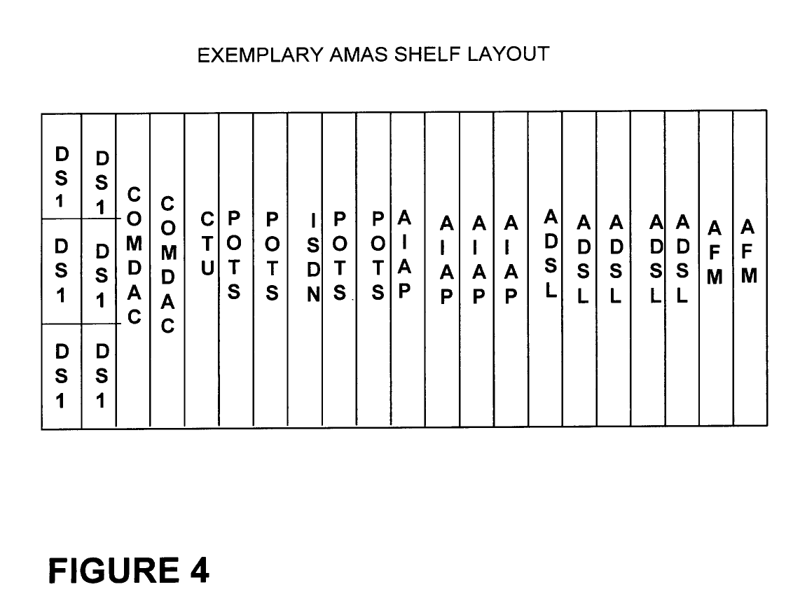

As a predicate to a more detailed discussion of the invention, it is useful to briefly consider an exemplary layout of application packs in an AMAS system. Such an exemplary layout is shown in FIG. 4. Within the illustrated AMAS system, a set of common control circuit packs provides the system “feeder” bandwidth (“DS 1” circuit cards). In a traditional AMAS STM based system, the feeder bandwidth is transported back to a digital circuit switch such as a Lucent 5 ESS switch. The common control packs labeled COMDAC (1 and 2) operate to provide the embedded software control for the shelf via an embedded central processing unit (CPU), and the central transmission “HUB” for the core time division multiplexing and Time Slot Interchanger functions for the AMAS shelf. In addition, the COMDAC, in coordination with the CTU common circuit pack, provides test access control for metallic loop testing through telephone company legacy test systems.

Hence, in the traditional AMAS system, the system is fed from the left side of the figure via DS 1 interfaces from the local digital switch; the COMDAC communicates with the switch over control channels within specific DS 1 interfaces, and upon direction from the switch, cross connects the feeder bandwidth in the form of a timeslot to a distribution “spoke” which serially connects to the 16 application pack slots beginning with the application pack labeled “POTS” in the figure. It is of interest to note that, while only one such COMDAC is actually necessary, the second may be operated as a hot standby. The four application packs labeled POTS (“plain old telephone service”) and the application pack labeled ISDN operate on the VF lines in a conventional manner and are capable of digitizing and multiplexing up to 192 VF lines. These application packs interface with the narrowband backplane of the AMAS and ultimately with the narrowband DS-1 I/O interface for the shelf. The six ADSL application packs shown in the figure are controlled by the COMDAC and operate to provide up to 160 broadband ADSL lines for subscribing end users. As such those ADSL application packs interface with the broadband backplane of the AMAS and, via the Access Facility Mux (AFM) application pack, with the broadband channel serving the ATM packet switch.

It is important to note that the AMAS system permits 2 distinct modes of backplane bearer channel traffic to be carried: 1) via traditional time division multiplexed (TDM) operation, and 2) via Asynchronous Transfer Mode (ATM) which is implemented using an ATM Cell Bus. The two modes of transport enable the invention described herein to “bridge” the connection between the native STM bearer traffic and the ATM packet based transport. It should also be noted that many variations of application packs can be specified for the AMAS shelf and that the specific choice of packs described herein is intended to be exemplary of the methodology of the invention. All such variations are, however, within the contemplation of the invention.

In the preferred embodiment of the invention, a new server card, which the inventors have designated as an Access Integrator Application Pack (AIAP), is introduced to AMAS system, as shown in the center of the application layout of FIG. 4, that AIAP being interfaced with the broadband backplane of the AMAS. An AIAP occupies one or more application pack slots in the AMAS shelf and each AIAP includes the capability to terminate eight DS-1 TDM feeders from a single SLC-5 Dual Channel Bank (or four such feeders each from two SLC-96 Channel Banks, or eight DS-1 feeders from other vendor's legacy DLC products) thereby terminating 192 DS-0 equivalent lines. The AIAP includes the processing capability to perform all of the 5 essential functions described above as characterizing the invention, and operates to communicate over the broadband backplane of the AMAS shelf through the Access Facility Mux (AFM) card to a serving packet switch. In particular, it is noted that the AIAP accepts as an input the STM, TDM multiplexed output of a legacy SLC-5 shelf (or equivalent DCB equipment) and converts it to an ATM data stream. That ATM data stream would then be processed by the Access Facility Mux for transport to the serving packet switch. An advantage of the AIAP embodiment is that processing power for accomplishing the interface function is added modularly as lines are added—each AIAP serving 192 lines.

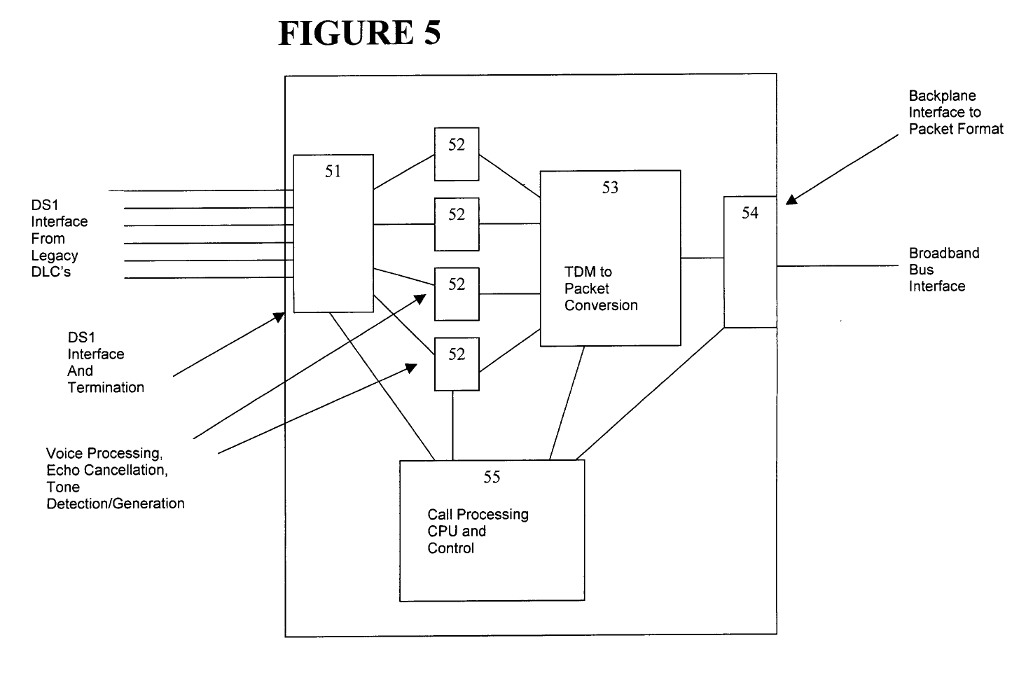

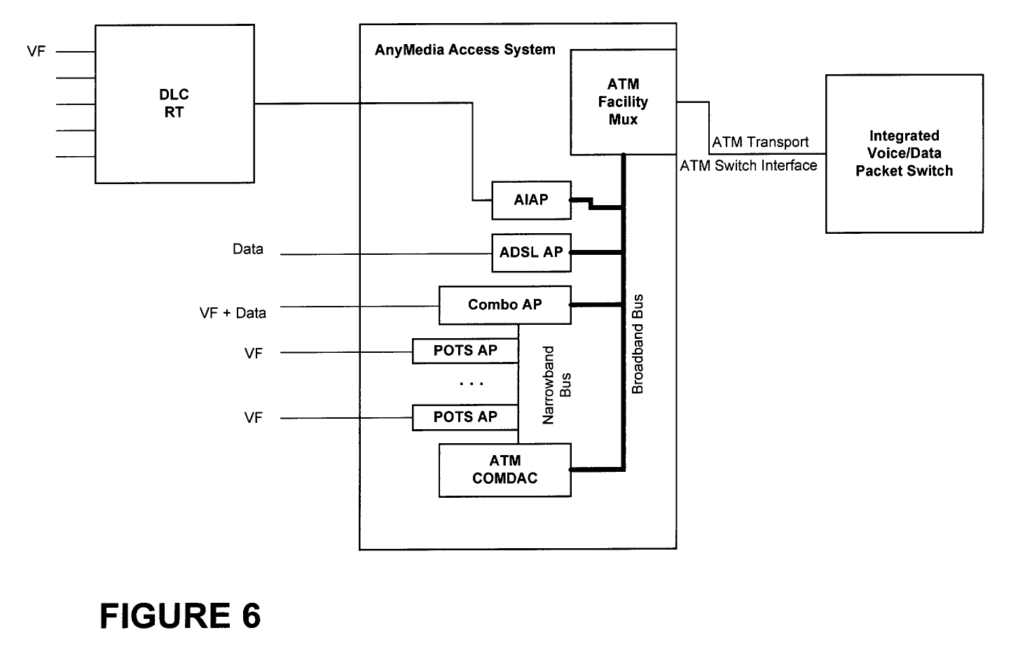

A more detailed functional description of the AIAP embodiment of the invention is provided hereafter in conjunction with the functional diagram of FIG. 5. As shown in the figure, the AIAP embodiment includes a circuit function 51 to receive and terminate serial data in the form of a DS 1 or other traditional TDM format from the legacy DLC equipment. This input data is supplied to a data processing function 53 within the AIAP which can buffer several time intervals of data from a specific subscriber, and associate the TDM data to a specific packet or channel within the ATM or IP packet domain. This process is referred to within the ATM domain as segmentation and reassembly (SAR) processing of data and in the IP domain as packetization processing.

In addition, it is important to note that, during the conversion process from TDM to packet, delays are often inserted within the data transmission path for a variety of reasons. These delays are associated with data storage and buffering, and more importantly, with the packet based transmission; “cells” as they are described can incur delay variation which is associated with cell queuing as a result of network congestion. These anomalies do not exist within the traditional synchronous transfer mode TDM systems since the channel pipe is always ready for transmission and carries idle time slot information when communications are quiet. To address this delay associated with the packet network, the AIAP function preferably contains a mechanism 52 to provide cancellation of echo which can be realized in a voice communications system having delay greater than several milliseconds in round-trip propagation. That AIAP element may also provide other functions such as voice processing tone generators, receivers and decoders to address the consideration that the packet domain is typically exclusively message based with respect to handling call control and handshaking elements often referred to as “signaling”.

Finally the overall functional control of the AIAP will preferably be via an embedded controller 55 which is capable of converting the call processing and control protocol within the ATM domain to the appropriate call control and processing signals within the TDM domain. All of the control and transmission data, upon conversion to packet form (either ATM or IP), are then presented to and transported via the ATM backplane 54 to the ATM feeder multiplexer in ATM format. These signals are transported then from the shelf to an ATM switch where they are processed by the network.

The interrelationship of the AMAS shelf, the AIAP card and the legacy DLC signals is schematically illustrated in FIG. 6. As will be seen the figure, the AMAS shelf incorporates a variety of application packs, including the ATM COMDAC, several POTS application cards, at least one COMBO application card (which operates to service both VF and data lines), at least one ADSL application card and at least one AIAP application card. Except for the POTS application cards, which are interfaced to the narrowband bus of the AMAS shelf, all of the remaining cards interface with the broadband bus of the shelf. The broadband bus in turn provides an interface to the ATM Facility Mux, which connects to the broadband transport facility connecting the RT with the ATM packet switch.

Considering specifically the AIAP card of the AMAS shelf in FIG. 6, it will be seen that the input to the AIAP card is the STM/TDM output of one or more legacy DLC shelves at that RT. Thus, the legacy DLCs carry out the analog/digital conversion and TDM multiplexing for the VF lines served by a given DLC, and the STM/TDM output of that DLC is being converted by the AIAP to an asynchronous, ATM data stream. The output of the AIAP is then routed via the broadband bus to the ATM Facility Mux and ultimately to the ATM packet switch. Thus, as previously indicated, the method and architecture of the invention provides a cost-effective conversion of narrowband legacy STM/TDM signals to a broadband asynchronous ATM format compatible with the packet transport systems that increasingly characterize the interexchange networks.

As indicated above, the AIAP could also be arranged to interface as an application pack on a DSLAM, as an application pack on an ATM Access Multiplex, or as a blade on an ATM Router. Similarly, it could be used at the central office as a server card on a Line Access Gateway (LAG). Implementation of such alternative configurations would be apparent to those skilled in the art, and accordingly no further detail of such implementation is warranted here.

Although the AIAP embodiment described above has the advantage that it does not burden the processing capability of Packet COMDAC on the AMAS shelf with additional STM traffic, the invention can also be implemented without using the AIAP implementation. One alternative embodiment of the invention would, as an illustrative example, terminate up to 120 lines (five DS-1s) from legacy DLCs through a five-port DS-1 Application Pack onto the narrowband bus of the AMAS shelf, communicating that traffic to the Packet COMDAC as though it had originated from conventional application packs on the AMAS shelf (e.g. as three POTS-32 application packs). The COMDAC would then provide the processing capability for STM to ATM conversion and associated functions—those functions supported by the AIAP processing capability in the AIAP embodiment. This implementation is limited to 120 lines per DS-1 Application Pack by the bandwidth of the narrowband bus on the AMAS shelf. Depending on the narrowband load already on the AMAS shelf, this additional load may require that additional processing capability be provided for the Packet COMDACS.

Yet another alternative embodiment of the invention would bring the DS-1 feeders from the legacy DLCs into the Packet COMDAC of the AMAS shelf through the DS-1 Feeder positions of the AMAS shelf (i.e., the six slots indicated as “DS-1” at far left position of AMAS shelf layout of FIG. 4). This capability is enabled because the original function of these positions in the shelf (as STM feeders to the AMAS shelf) are no longer required once all feeder connections to the serving packet switch are made through the broadband AFM.

In the case of this alternative embodiment, up to 20 DS 1 interfaces or 480 DSO's of traffic can be carried up to the shelf and transported to the ATM COMDAC function. On the COMDAC, and as described previously with regard to the AIAP function, the serial TDM signals associated with each DS 1 can be routed through appropriate echo cancellation and tone generation and detection functions (typically a DSP farm); the signals would then be routed onto the segmentation and reassembly processor function and then out to the backplane over the CellBus and upstream to the AFM. Hence, while the AIAP function constitutes the preferred embodiment for conversion from TDM (STM) to ATM (packet), other methods for providing the fundamental conversion functionality within the AMAS shelf are also within the contemplation of the invention.

In summary, the invention provides a solution to the problem of converting the embedded base of Digital Loop Carrier access systems from a Synchronous Transfer Mode transport and Time Division Multiplexed network interface paradigm to an Asynchronous Transfer Mode transport and ATM network interface paradigm, to achieve compatibility with the increasingly packet-switched character of the interexchange networks. This goal is achieved by providing a new processing architecture at a remote terminal that operates on the output of legacy DLC equipment to convert that legacy output signal from STM/TDM to an asynchronous data stream. Various embodiment of that architecture are disclosed, including the introduction of a new processing means for carrying out the desired signal conversion, and associated functions, as well as use of existing processing capability for those functions.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention and is not intended to illustrate all possible forms thereof. It is also understood that the words used are words of description, rather that limitation, and that details of the structure may be varied substantially without departing from the spirit of the invention and the exclusive use of all modifications which come within the scope of the appended claims is reserved.

1. An apparatus for a remote concentrator terminal comprising:
processing means established to provide a conversion between synchronous and asynchronous transport protocols.

2. The apparatus of claim 1 further comprising a storage means established to buffer input synchronous transport mode data for given inputs to the remote concentrator terminal, and to associate the buffer data with a specific transport element of the packet based network.

3. The apparatus of claim 2 further comprising a controller operative to convert call processing and control protocol between the asynchronous transport mode and the synchronous transport mode.

4. The apparatus of claim 3 further comprising an input means arranged to receive and terminate data in a synchronous transport mode format

5. The apparatus of claim 3 further comprising echo canceling means.

6. The apparatus of claim 3 further comprising a voice processing tone generator.

7. The apparatus of claim 3 further comprising at least one receiver and decoder.

8. The apparatus of claim 4 wherein elements of the apparatus are integrated into a circuit board arranged to for plug-in to a defined slot at the remote terminal.

9. The apparatus of claim 1 wherein the remote concentrator terminal includes one or more line cards arranged to digitize and multiplex signals from a plurality of input lines and at least one packet-mode multiplexer having an output connected to the packet-based network, and further wherein the apparatus provides a conversion between a synchronous transport protocol at the output of the line cards and an asynchronous transport protocol provided as an input to the packet-mode multiplexer.

10. A method for providing asynchronous transport in a Digital Loop Carrier System comprising the steps of:
providing at a remote terminal site:
a a processor operable to perform a conversion between synchronous and asynchronous transport protocols; and
an interface to a broadband transport link having an input connected to an output of said processor;
connecting a signal provided in a synchronous protocol to an input of said processor; and
causing said processor to convert said input synchronous protocol signal to an asynchronous protocol signal.

11. The method of claim 10 wherein the processor is further operative to effect echo cancellation.

12. The method of claim 10 wherein the processor is further operative to effect voice-processing tone generation.

13. The method of claim 10 wherein the processor is further operative to provide an interface between voice-band signaling at an input side of the Digital Loop Carrier System and message-based signaling associated with the asynchronous protocol signal.

14. An architecture for effecting a conversion at a remote terminal of legacy synchronous protocol signals to asynchronous protocol signals comprising:
a processor located proximately to the remote terminal site operative to provide a conversion from a synchronous protocol signal to an asynchronous protocol signal;
a broadband interface disposed between an output of the processor and a broadband transport channel connecting the remote terminal with a broadband network communications node; and
means for connecting an output of synchronous Digital Loop Carrier signals provided at the remote terminal to an input of said processor.

15. The architecture of claim 14 wherein the processor is further operative to effect echo cancellation.

16. The architecture of claim 14 wherein the processor is further operative to effect voice-processing tone generation.

17. The architecture of claim 14 wherein the processor is further operative to provide an interface between voice-band signaling at an input side of the Digital Loop Carrier System and message-based signaling associated with the broadband transport channel.
